(19) United States
(12) Patent Application Publication
(10) Pub. No.: US 2020/0086480 A1
(43) Pub. Date: Mar. 19, 2020

(54) SYSTEM AND METHOD FOR CONTROLLING ACTUATORS OF AN ARTICULATED ROBOT

(71) Applicant: FRANKA EMIKA GMBH, München (DE)

(72) Inventors: Sami Haddadin, Hannover (DE); Lars Johannsmeier, München (DE)

(21) Appl. No.: 16/610,714

(22) PCT Filed: May 29, 2018
(86) PCT No.: PCT/EP2018/064059

§ 371 Date: Nov. 4, 2019

(30) Foreign Application Priority Data
May 29, 2017 (DE) 10 2017 005 081.3

(51) Int. Cl. B25J 9/16; B25J 9/00

(52) U.S. Cl. CPC B25J 9/163; B25J 9/1633; B25J 9/0081

(57) ABSTRACT

The invention relates to a system for controlling actuators of an articulated robot and for enabling the robot executing a given task, including a first unit providing a specification of robot skills s selectable from a skill space depending on the task, a second unit, wherein the second unit is connected to the first unit and further to a learning unit and to an adaptive controller, wherein the adaptive controller receives skill commands χ_{cmd}, wherein the skill commands χ_{cmd} include the skill parameters Pₗ, wherein based on the skill commands χ_{cmd} the controller controls the actuators of the robot, wherein the actual status of the robot is sensed by respective sensors and/or estimated by respective estimators and fed back to the controller and to the second unit, wherein based on the actual status, the second unit determines the performance Q(t) of the skill carried out by the robot, and wherein the learning unit receives P_{D}, and Q(t) from the second unit, determines updated skill parameters Pₗ(t) and provides Pₗ(t) to the second unit to replace hitherto existing skill parameters Pₗ.

### CROSS-REFERENCE TO RELATED APPLICATIONS

The present application is the U.S. National Phase of PCT/EP2018/064059, filed on 29 May 2018, which claims priority to German Patent Application No. 10 2017 005 081.3, filed on 29 May 2017, the entire contents of which are incorporated herein by reference.

### BACKGROUND

### Field

The invention relates to a system and method for controlling actuators of an articulated robot.

### Related Art

The traditional way of programming complex robots is sometimes sought to become more intuitive, such that not only experts but also shopfloor workers, in other words laymen, are able to utilize robots for their work. The terms “skill-” and “task-based programming” are very important in this context. “Skills” are in particular some formal representation of predefined actions or movements of the robot. Several approaches to programming with skills exist, e.g., publications [1], [2], and [3], and they are, in particular, mostly viewed independently from the controller, i.e., in particular, the controller only executes commands calculated by the skills implementation. From this it can be seen that the underlying controller is a common factor for manipulation skills and thus provides a set of parameters that is shared by them. It is, however, according to general knowledge not efficient and often not even feasible to use the same parameter values for all manipulation skills. Typically, it is even not possible considering the same skill in different environments.

Depending on the particular situation, the parameters have to be adapted in order to account for different environment properties such as rougher surfaces or different masses of involved objects. Within given boundaries of certainty the parameters could be chosen such that the skill is fulfilled optimally, or at least close to optimal with respect to a specific cost function. In particular, this cost function and constraints are usually defined by the human user with some intention, e.g., low contact forces, short execution time or a low power consumption of the robot. A significant problem in this context is the tuning of the controller parameters in order to find regions in the parameter space that minimize such a cost function or are feasible in the first place without necessarily having any pre-knowledge about the task other than the task specification and the robots abilities.

Several approaches were proposed that cope with this problem in different ways such as publication [4], in which learning motor skills by demonstration is described. In publication [5], a Reinforcement Learning based approach to acquiring new motor skills from demonstration is introduced. The authors of publications [6], [7] employ Reinforcement Learning methods to learn motor primitives that represent a skill. In publication [8] a supervised learning by demonstration approach is used with dynamic movement primitives to learn bipedal walking in simulation. An early approach utilizing a stochastic real-valued reinforcement learning algorithm in combination with a nonlinear multilayer artificial neural network in order to learn robotic skills can be found in publication [9]. Soft robotics is shown in publication [10], while impedance control to apply the idea to complex manipulation problems is shown in publication [11]. An adaptive impedance controller is introduced in publication [12]. Both are adapted during execution, depending on the motion error and based on four physically meaningful meta parameters. From this the question arises how these meta parameters are to be chosen with respect to the environment and the problem at hand.

### SUMMARY

It is the objective of the invention to provide a system and a method for improved learning of robot manipulation skills.

A first aspect of the invention relates to a system for controlling actuators of an articulated robot and for enabling the robot to execute a given task, including:
a first unit providing a specification of robot skills s selectable from a skill space depending on the task, with a robot skill s being defined as a tuple

(S, O, Cₚᵣₑ, Cₑᵣᵣ, C_{suc}, Rₘ, χ_{cmd}, X, P, Q) with

S: a Cartesian product of I subspaces ζᵢ: S=ζᵢ₌₁×ζᵢ₌₂× . . . ×ζ_{i=I}

with i={1, 2, . . . , I} and I≥2,

O: a set of physical objects,

Cₚᵣₑ: a precondition,

Cₑᵣᵣ: an error condition,

C_{suc}: a success condition,

R: a nominal result of ideal skill execution,

χ_{cmd}: skill commands,

X: physical coordinates,

P: skill parameters, with P consisting of three subsets Pₜ, Pₗ, P_{D}, with Pₜ being the parameters resulting from a priori knowledge of the task, Pₗ being the parameters not known initially which need to be learned and/or estimated during execution of the task, and P_{D} being constraints of parameters Pₗ,

Q: a performance metric, while Q(t) is denoting the actual performance of the skill carried out by the robot, and
a second unit, wherein the second unit is connected to the first unit and further to a learning unit and to an adaptive controller, wherein the adaptive controller receives skill commands χ_{cmd}, wherein the skill commands χ_{cmd} include the skill parameters Pₗ, wherein based on the skill commands χ_{cmd} the controller controls the actuators of the robot, wherein the actual status of the robot is sensed by respective sensors and/or estimated by respective estimators and fed back to the controller and to the second unit, wherein based on the actual status, the second unit determines the performance Q(t) of the skill carried out by the robot, and wherein the learning unit receives P_{D}, and Q(t) from the second unit, determines updated skill parameters Pₗ(t) and provides Pₗ(t) to the second unit to replace hitherto existing skill parameters Pₗ.

Preferably, the subspaces ζᵢ include a control variable, in particular, a desired variable, or an external influence on the robot or a measured state, in particular, an external wrench including, in particular, an external force and an external moment.

A preferred adaptive controller is derived as follows:

Consider the robot dynamics

M(q)\ddot{q}+C(q,\dot{q})\dot{q}+g(q)=τᵤ+τₑₓₜ (1)

where M(q) denotes the symmetric, positive definite mass matrix, C(q, \dot{q})\dot{q} the Coriolis and centrifugal torques and g(q) the gravity vector. The control law is defined as:

τᵤ(t)=J(q)^{T}(−F_{ff}−K(t)e−Dė)+τᵣ (2)

where F_{ff}(t) denotes the feed-forward wrench, K(t) the stiffness matrix, D the damping matrix and J(q) the Jacobian. The position and velocity error are denoted by e=[eₜ, eᵣ]^{T} and ė=\dot{x}*−\dot{x}, respectively. eₜ=x*−x is the translational position error and eᵣ=θ*−θ the rotational angle axis error. The dynamics compensator τᵣ is defined as:

τᵣ=M(q)\ddot{q}*+C(q,\dot{q})\dot{q}*+g(q)−sign(ϵ)ν̅ (3).

The feed forward wrench F_{ff} is defined as:

F_{ff}=F_{d}(t)+∫ₜ_{ₛ}^{t}δF_{ff}dt+F_{ff,0} (4)

where F_{d}(t) is an optional initial time dependent trajectory and F_{ff,0} is the initial value of the integrator. The controller adapts feed forward wrench and stiffness via

$$\begin{matrix}δ {F}_{ff} ( t ) = {F}_{ff} ( t ) - {F}_{ff} ( t - T ) & ( 5 ) \\ … = α ( ϵ - {γ}_{α} ( t ) {F}_{ff} ( t ) ) \\ and & ( 6 ) \\ δ K ( t ) = K ( t ) - K ( t - T ) & ( 7 ) \\ … = β ( diag ( ϵ ∘ e ) - {γ}_{β} ( t ) K ( t ) ) . & ( 8 )\end{matrix}$$

The adaptive tracking error is defined as

ϵ=e+κ\dot{ϵ} (9)

with κ>0. The positive definite matrices α, β, γₐ and γ_{β} represent the learning rates for the feed forward and stiffness and the forgetting factors, respectively. Damping D is designed according to publication [21] and T is the sample time of the controller.

With the explanations above, the preferred adaptive controller is basically given.

A preferred γₐ and γ_{β} are derived via constraints as follows:

The first constraint of an adaptive impedance controller is the upper bound \dot{K}ₘₐₓ on the speed of stiffness adaptation. Inserting c_{α}:=αγ_{α} and c_{β}:=βγ_{β} into (8) leads, together with the bounded stiffness rate of change, to the relation:

$${\dot{K}}_{max} = {max}_{t > 0} 〚 \frac{1}{T} β ( ϵ ( t ) e ( t ) - \frac{{c}_{β}}{β} K ( t ) ) 〛 . \qquad ( 10 )$$

If it is assumed that K (t=0) and ė=0, eₘₐₓ is preferably defined as the amount of error at which

$${\dot{K}}_{max} = \frac{β {e}_{max}^{2}}{T}$$

holds. Furthermore, Kₘₐₓ denotes the absolute maximum stiffness, another constraint for any real-world impedance controlled robot. Then, the maximum value for β can be written as:

$${β}_{max} = \frac{{\dot{K}}_{max} T}{{e}_{max}^{2}} . \qquad ( 11 )$$

Since δK (t)=0 and ė=0 when Kₘₐₓ is reached, (10) can be rewritten as

$$0 = {β}_{max} ( {e}_{max}^{2} - \frac{{c}_{β}}{{β}_{max}} {K}_{max} ) . \qquad ( 12 )$$

Finally, the adaptation parameters become

$${c}_{β} = \frac{{β}_{max} {e}_{max}^{2}}{{K}_{max}} and {γ}_{β} = \frac{{c}_{β}}{{β}_{max}} .$$

Finding the adaptation of feed forward wrench is preferably done analogously. This way, the upper limits for α and β are, in particular, related to the inherent system capabilities Kₘₐₓ and Fₘₐₓ leading to the fastest possible adaptation.

With the above explanations, preferred γₐ and γ_{β} are derived.

The introduced skill formalism focuses, in particular, on the interplay between abstract skill, meta learning (by the learning unit) and adaptive control. The skill provides, in particular, desired commands and trajectories to the adaptive controller together with meta parameters and other relevant quantities for executing the task. In addition, a skill contains, in particular, a quality metric and parameter domain to the learning unit, while receiving, in particular, the learned set of parameters used in execution. The adaptive controller commands, in particular, the robot hardware via desired joint torques and receives sensory feedback. Finally, the skill formalism, in particular, makes it possible to easily connect to a high-level task planning module. The specification of robot skills s are preferably provided as follows from the first unit:

The following preferred skill formalism is object-centered, in the sense that the notion of the manipulated objects are of main concern. The advantage of this approach is its simple notation and intuitive interpretability. The aspect of greater intuitiveness is based on the similarity to natural language:

Definition 1 (Skill): A skill s is an element of the skill-space. It is defined as a tuple (S, O, Cₚᵣₑ, Cₑᵣᵣ, R, χ_{cmd}, X, P, Q).

Definition 2 (Space): Let S be the Cartesian product of I subspaces ζᵢ= [symbol] ^{m}^{ᵢ}^{×n}^{ᵢ} relevant to the skill s, i.e.: S=ζᵢ₌ⱼ×ζᵢ₌₂× . . . ×ζ_{i=I} with i={1, 2, . . . , I} and I≥2.

Preferably, the subspaces ζᵢ include a control variable, in particular, a desired variable, or an external influence on the robot or a measured state, in particular, an external wrench including, in particular, an external force and an external moment.

Definition 3 (Object): Let o represent a physical object with coordinates ^{o}X(t)∈S associated with it. O denotes the set of physical objects o∈O relevant to a skill s with nₒ=|O| and nₒ>0. Moreover, X(t) is defined as X(t)=(^{o}^{ₙ}X(t), . . . , ^{o}^{ₙ}X(t))^{T}. Note that in these considerations the set O is not changed during skill execution, i.e., nₒ=const.

Definition 4 (Task Frame): The task frame ^{o}R_{TF}(t) denotes the rotation from frame TF to the base frame 0. Note that we assume ^{o}R_{TF}(t)=const.

Definition 5 (Parameters): P denotes the set of all skill parameters consisting of three subsets Pₜ, Pₗ and P_{D}. The set Pₜ⊂P contains all parameters resulting from a priori task knowledge, experience and the intention under which the skill is executed. In this context, it is referred to Pₜ also as task specification. The set Pₗ⊂P contains all other parameters that are not necessarily known beforehand and need to be learned or estimated. In particular, it contains the meta parameters (α, β, γ_{α}, γ_{β}) for the adaptive controller. The third subset P_{D}⊂P defines the valid domain for Pₗ, i.e., it consists of intervals of values for continuous parameters or sets of values for discrete ones. Thus, P_{D} determines the boundaries when learning Pₗ.

Conditions: There are preferably three condition types involved in the execution of a skill: preconditions, failure conditions and success conditions. They all share the same basic definition, yet their application is substantially different. Their purpose is to define the borders and limits of the skill from start to end:

Definition 6 (Condition): Let C⊂S be a closed set and c(X(t)) a function c: S→B where B={0, 1}. A condition holds iff c(X(t))=1. Note that the mapping itself depends on the specific type of condition.

Definition 7 (Precondition): Cₚᵣₑ denotes the chosen set for which the precondition defined by cₚᵣₑ(X(t)) holds. The condition holds, i.e., cₚᵣₑ(X(t₀))=1, iff ∀x∈X: x(t₀)∈Cₚᵣₑ. to denotes the time at start of the skill execution. This means that at the beginning of skill execution the coordinates of every involved object must lie in Cₚᵣₑ.

Definition 8 (Error Condition): Cₑᵣᵣ denotes the chosen set for which the error condition cₑᵣᵣ(X(t)) holds, i.e., cₑᵣᵣ(X(t))=1. This follows from ∃x∈X: x(t)∈Cₑᵣᵣ. If the error condition is fulfilled at time t, skill execution is interrupted. Herein, assumptions about how this error state is resolved are not made herein since this depends, in particular, on the actual skill implementation and the capabilities of high-level control and planning agency.

Definition 9 (Success Condition): C_{suc} denotes the chosen set for which the success condition defined by c_{suc}(X(t)) holds, i.e., c_{suc}(X(t))=1 iff ∀x∈X: x(t)∈C_{suc}. If the coordinates of all involved objects are within C_{suc} the skill execution can terminate successfully. With this it is not stated that the skill has to terminate.

Definition 10 (Nominal Result): The nominal result R∈S is the ideal endpoint of skill execution, i.e., the convergence point. Although the nominal result R is the ideal goal of the skill, its execution is nonetheless considered successful if the success conditions C_{suc} hold. Nonetheless X(t) converges to this point. However, it is possible to blend from one skill to the next if two or more are queued.

Definition 11 (Skill Dynamics): Let X: [t₀,∞]→P be a general dynamic process, where t₀ denotes the start of the skill execution. The process can terminate if (∀ c_{suc}∈C_{suc}: c_{suc}(X(t))=1)∨(∃ cₑᵣᵣ∈Cₑᵣᵣ: cₑᵣᵣ(X(t))=1).

It converges to the nominal result R. This dynamic process encodes what the skill actually does depending on the input, i.e., the concrete implementation. This is preferably one of: a trajectory generator, a DMP, or some other algorithm calculating sensor based velocity or force commands. The finish time tₑ is not necessarily known a priori. For example, for a search skill it cannot be determined when it terminates because of the very nature of the search problem.

Definition 12 (Commands): Let χ_{cmd}⊂X(t) be the skill commands, i.e., a desired trajectory consisting of velocities and forces defined in TF sent to the controller.

Definition 13 (Quality Metric): Q denotes the set of all 2-tuples (w,f_{q}(X(t)) with 0<w<1 and constraints f_{c,i}(X(t)). Furthermore let q=Σᵢwᵢf_{q,i}(X(t))∀(wᵢ, f_{q,i}(X(t)))∈Q.

The quality metric is a means of evaluating the performance of the skill and to impose quality constraints on it. This evaluation aims at comparing two different implementations of the same skill or two different sets of parameters P. The constraints can, e.g., be used to provide a measure of quality limits for a specific task (e.g., a specific time limit). Note, that the quality metric reflects some criterion that is derived from the overall process in which the skill is executed or given by a human supervisor. Moreover, it is a preferred embodiment that a skill has several different metrics to address different demands of optimality.

With the above, the specification of robot skills s is provided in a preferable way from the first unit.

The learning unit is preferably derived as follows:

The learning unit applies meta learning, which in particular means finding the right (optimal) parameters p*∈Pₗ for solving a given task. Requirements: In order to learn the controller meta parameters together with other parameters such as execution velocity, several potentially suitable learning methods are to be evaluated. The method will face the following issues:
Problems have no feasible analytic solution,
Gradients are usually not available,
Real world problems are inherently stochastic,
No assumptions minima or cost function convexity,
Violation of safety, task or quality constraints, and
Significant process noise and many repetitions.

Therefore, a suitable learning algorithm will have to fulfill the subsequent requirements:
Numerical black-box optimization,
No gradients required,
Stochasticity has to be regarded,
Global optimizer,
Handle unknown and noisy constraints, and
Fast convergence rates.

Preferably, one of the following algorithms or a combination thereof for meta learning is applied in the learning unit: Grid Search, Pure Random Search, Gradient-descent family, Evolutionary Algorithms, Particle Swarm, Bayesian Optimization.

Generally, gradient-descent based algorithms require a gradient to be available. Grid search and pure random search, as well as evolutionary algorithms, typically do not assume stochasticity and cannot handle unknown constraints without extensive knowledge about the problem they optimize, i.e., make use of well-informed barrier functions. The latter point also applies to particle swarm algorithms. Only Bayesian optimization in accordance to publication [25] is capable of explicitly handling unknown noisy constraints during optimization. Another and certainly one of the major requirements is little, if possible, no manual tuning to be necessary. Choosing, for example, learning rates or making explicit assumptions about noise would break with this intention. Obviously, this requirement depends to a great deal on the concrete implementation, but also on the optimizer class and its respective requirements.

Considering all mentioned requirements, the spearmint algorithm known from publications [26], [27], [28], and [25] is preferably applied. This particular implementation requires no manual tuning, it is only required to specify the prior and the acquisition function in advance once.

More preferably, a Bayesian Optimization is applied. Preferably, it is realized and implemented as follows:

In general, Bayesian optimization (BO) finds the minimum of an unknown objective function ƒ(p) on some bounded set X by developing a statistical model of ƒ(p). Apart from the cost function, it has two major components, which are the prior and the acquisition function. Prior: In particular, a Gaussian process is used as prior to derive assumptions about the function being optimized. The Gaussian process has a mean function m: χ→ [symbol] and a covariance function K: χ×χ→ [symbol] . As a kernel, preferably, the automatic relevance determination (ARD) Matérn 5/2 kernel is used, which is given by:

$${K}_{M 52} ( p , {p}^{′} ) = {θ}_{0} ( 1 + \sqrt{5 {r}^{2} ( p , {p}^{′} )} + \frac{5}{3} {r}^{2} ( p , {p}^{′} ) {e}^{- \sqrt{5 {r}^{2} ( p , {p}^{′} )}} ) with$$

$${r}^{2} ( p , {p}^{′} ) = {\sum }_{i = 1}^{d} \frac{{( {p}_{i} - {p}_{i}^{′} )}^{2}}{{θ}_{i}^{2}} .$$

This kernel has d+3 hyperparameters in d dimensions, i.e., one characteristic length scale per dimension, the covariance amplitude θ₀, the observation noise v and a constant mean m. These kernel hyperparameters are integrated out by applying Markov chain Monte Carlo (MCMC) via slice sampling in publication [29]. Acquisition function: Preferably a predictive entropy search with constraints (PESC) is used as a means to select the next parameters x to explore, as described in publication [30]. Cost function: Preferably a cost metric Q defined as above is used directly to evaluate a specific set of parameters Pₗ. Also, the success or failure of the skill by using the conditions C_{suc} and Cₑᵣᵣ can be evaluated. Bayesian optimization can make direct use of the success and failure conditions as well as the constraints in Q as described in publication [25].

The invention presents the following advantages: The adaptive controller from publication [12] is extended to Cartesian space and full feed forward tracking. A novel meta parameter design for the adaptive controller based on real-world constraints of impedance control is provided. A novel formalism to describe robot manipulation skills and bridge the gap between high-level specification and low-level adaptive interaction control is introduced. Meta learning via Bayesian Optimization in publication [14], which is frequently applied in robotics in publications [16], [17], [18], is the missing computational link between adaptive impedance control and high-level skill specification. A unified framework that composes all adaptive impedance control, meta learning and skill specification into a closed loop system is introduced.

According to an embodiment of the invention the adaptive controller adapts feed forward wrench and stiffness via δF_{ff}=F_{ff}(t)−F_{ff}(t−T).

According to another embodiment of the invention the learning unit carries out a Bayesian and/or a HiREPS optimization/learning.

HiREPS is the acronym of “Hierarchical Relative Entropy Policy Search”.

According to another embodiment of the invention, the system includes a data interface with a data network, and the system is designed and set up to download system-programs for setting up and controlling the system from the data network.

According to another embodiment of the invention, the system is designed and set up to download parameters for the system-programs from the data network.

According to another embodiment of the invention, the system is designed and set up to enter parameters for the system-programs via a local input-interface and/or via a teach-in-process, with the robot being manually guided.

According to another embodiment of the invention, the system is designed and set up such that downloading system-programs and/or respective parameters from the data network is controlled by a remote station, and wherein the remote station is part of the data network.

According to another embodiment of the invention, the system is designed and set up such that system-programs and/or respective parameters locally available at the system are sent to one or more participants of the data network based on a respective request received from the data network.

According to another embodiment of the invention, the system is designed and set up such that system-programs with respective parameters available locally at the system can be started from a remote station, and wherein the remote station is part of the data network.

According to another embodiment of the invention, the system is designed and set up such that the remote station and/or the local input-interface includes a human-machine-interface HMI designed and setup for entry of system-programs and respective parameters and/or for selecting system-programs and respective parameters from a multitude system-programs and respective parameters.

According to another embodiment of the invention, the human-machine-interface HMI is designed and set up such that entries are possible via “drag-and-drop”-entry on a touchscreen, a guided dialogue, a keyboard, a computer-mouse, a haptic interface, a virtual-reality-interface, an augmented reality interface, an acoustic interface, via a body tracking interface, based on electromyographic data, based on elektroenzephalographic data, via a neuronal interface, or a combination thereof.

According to another embodiment of the invention, the human-machine-interface HMI is designed and set up to deliver auditive, visual, haptic, olfactoric, tactile, or electrical feedback or a combination thereof.

Another aspect of the invention relates to robot with a system as shown above and in the following.

Another aspect of the invention relates to a method for controlling actuators of an articulated robot and enabling the robot executing a given task, the robot including a first unit, a second unit, a learning unit, and an adaptive controller, the second unit being connected to the first unit, and further to a learning unit and to an adaptive controller, including the following steps:
providing a specification of robot skills s selectable from a skill space depending on the task by a first unit (101), with a robot skill s being defined as a tuple

(S, O, Cₚᵣₑ, Cₑᵣᵣ, C_{suc}, R, χ_{cmd}, X, P, Q) with

S: a Cartesian product of I subspaces ζᵢ: S=ζᵢ₌₁×ζᵢ₌₂× . . . ×ζ_{i=I}

with i={1, 2, . . . , I} and I≥2,

O: a set of objects,

Cₚᵣₑ: a precondition,

Cₑᵣᵣ: an error condition,

C_{suc}: a success condition,

R: a nominal result of ideal skill execution,

χ_{cmd}: skill commands,

X: physical coordinates,

P: skill parameters, with P consisting of three subsets Pₜ, Pₗ, P_{D}, with Pₜ being the parameters resulting from a priori knowledge of the task, Pₗ being the parameters not known initially and need to be learned and/or estimated during execution of the task, and P_{D} being constraints of parameters Pₗ,

Q: a performance metric, while Q(t) is denoting the actual performance of the skill carried out by the robot,
an adaptive controller receiving skill commands χ_{cmd} from a second unit,

wherein the second unit is connected to the first unit and further to a learning unit and to the adaptive controller and wherein the skill commands χ_{cmd} include the skill parameters Pₗ,
controlling the actuators of the robot by the controller and based on the skill commands) χ_{cmd}, wherein the actual status of the robot is sensed by respective sensors and/or estimated by respective estimators and fed back to the controller and to the second unit,
determining by the second unit and based on the actual status, the performance Q(t) of the skill carried out by the robot,
the learning unit receiving P_{D} and Q(t) from the second unit, and
determining updated skill parameters Pₗ(t) and providing Pₗ(t) to the second unit and replacing hitherto existing skill parameters Pₗ.

Preferably, the subspaces ζᵢ include a control variable, in particular, a desired variable, or a external influence on the robot or a measured state, in particular, an external wrench including, in particular, an external force and an external moment.

Another aspect of the invention relates to a computer system with a data processing unit, wherein the data processing unit is designed and set up to carry out a method according to one of the preceding alternatives.

Another aspect of the invention relates to a digital data storage with electronically readable control signals, wherein the control signals can coaction with a programmable computer system, so that a method according to one of the preceding alternatives is carried out.

Another aspect of the invention relates to computer program product including a program code stored in a machine-readable medium for executing a method according to one of the preceding alternatives, if the program code is executed on a computer system.

Another aspect of the invention relates to computer program with program codes for executing a method according to one of the preceding alternatives, if the computer program runs on a computer system.

The sources of prior art mentioned above and additional sources are the following publications:
[1]: M. R. Pedersen, L. Nalpantidis, R. S. Andersen, C. Schou, S. Bøgh, V. Krüger, and O. Madsen, “Robot skills for manufacturing: From concept to industrial deployment,” Robotics and Computer-Integrated Manufacturing, 2015.
[2]: U. Thomas, G. Hirzinger, B. Rumpe, C. Schulze, and A. Wortmann, “A new skill based robot programming language using uml/p state-charts,” in Robotics and Automation (ICRA), 2013 IEEE International Conference on. IEEE, 2013, pp. 461-466.
[3]: R. H. Andersen, T. Solund, and J. Hallam, “Definition and initial case-based evaluation of hardware-independent robot skills for industrial robotic co-workers,” in ISR/Robotik 2014; 41st International Sympo-sium on Robotics; Proceedings of. VDE, 2014, pp. 1-7.
[4]: P. Pastor, H. Hoffmann, T. Asfour, and S. Schaal, “Learning and gener-alization of motor skills by learning from demonstration,” in Robotics and Automation, 2009. ICRA'09. IEEE International Conference on. IEEE, 2009, pp. 763-768.
[5]: P. Pastor, M. Kalakrishnan, S. Chitta, E. Theodorou, and S. Schaal, “Skill learning and task outcome prediction for manipulation,” in Robotics and Automation (ICRA), 2011 IEEE International Conference on. IEEE, 2011, pp. 3828-3834.
[6]: J. Kober and J. Peters, “Learning motor primitives for robotics,” in Robotics and Automation, 2009. ICRA'09. IEEE International Conference on. IEEE, 2009, pp. 2112-2118.
[7]: J. Kober and J. R. Peters, “Policy search for motor primitives in robotics,” in Advances in neural information processing systems, 2009, pp. 849-856.
[8]: S. Schaal, J. Peters, J. Nakanishi, and A. Ijspeert, “Learning movement primitives,” in Robotics Research. The Eleventh International Symposium. Springer, 2005, pp. 561-572.
[9]: V. Gullapalli, J. A. Franklin, and H. Benbrahim, “Acquiring robot skills via reinforcement learning,” IEEE Control Systems, vol. 14, no. 1, pp. 13-24, 1994.
[10]: A. Albu-Schaffer, O. Eiberger, M. Grebenstein, S. Haddadin, C. Ott, T. Wimbock, S. Wolf, and G. Hirzinger, “Soft robotics,” IEEE Robotics & Automation Magazine, vol. 15, no. 3, 2008.
[11]: S. Part, “Impedance control: An approach to manipulation,” Journal of dynamic systems, measurement, and control, vol. 107, p. 17, 1985.
[12]: C. Yang, G. Ganesh, S. Haddadin, S. Parusel, A. Albu-Schäffer, and E. Burdet, “Human-like adaptation of force and impedance in stable and unstable interactions,” Robotics, IEEE Transactions on, vol. 27, no. 5, pp. 918-930, 2011.
[13]: E. Burdet, R. Osu, D. Franklin, T. Milner, and M. Kawato, “The central nervous system stabilizes unstable dynamics by learning optimal impedance,” NATURE, vol. 414, pp. 446-449, 2001. [Online]. Available: http://dx.doi.org/10.1038/35106566
[14] B. Shahriari, K. Swersky, Z. Wang, R. P. Adams, and N. de Freitas, “Taking the human out of the loop: A review of bayesian optimization,” Proceedings of the IEEE, vol. 104, no. 1, pp. 148-175, 2016.
[15]: M. D. McKay, R. J. Beckman, and W. J. Conover, “Comparison of three methods for selecting values of input variables in the analysis of output from a computer code,” Technometrics, vol. 21, no. 2, pp. 239-245, 1979.
[16]: R. Calandra, A. Seyfarth, J. Peters, and M. P. Deisenroth, “Bayesian optimization for learning gaits under uncertainty,” Annals of Mathematics and Artificial Intelligence, vol. 76, no. 1-2, pp. 5-23, 2016.
[17]: J. Nogueira, R. Martinez-Cantin, A. Bernardino, and L. Jamone, “Unscented bayesian optimization for safe robot grasping,” arXiv preprint arXiv:1603.02038, 2016.
[18]: F. Berkenkamp, A. Krause, and A. P. Schoellig, “Bayesian optimiza-tion with safety constraints: safe and automatic parameter tuning in robotics,” arXiv preprint arXiv: 1602.04450, 2016.
[19]: G. Ganesh, A. Albu-Schaffer, M. Haruno, M. Kawato, and E. Burdet, “Biomimetic motor behavior for simultaneous adaptation of force, impedance and trajectory in interaction tasks,” in Robotics and Au-tomation (ICRA), 2010 IEEE International Conference on. IEEE, 2010, pp. 2705-2711.
[20]: J.-J. E. Slotine, W. Li, et al., Applied nonlinear control. Prentice-hall Englewood Cliffs, N J, 1991, vol. 199, no. 1.
[21]: A. Albu-Schaffer, C. Ott, U. Frese, and G. Hirzinger, “Cartesian impedance control of redundant robots: Recent results with the DLR-light-weight-arms,” in IEEE Int. Conf. on Robotics and Automation, vol. 3, 2003, pp. 3704-3709.
[22]: G. Hirzinger, N. Sporer, A. Albu-Schäffer, M. Hahnle, R. Krenn, A. Pascucci, and M. Schedl, “Dlr's torque-controlled light weight robot iii—are we reaching the technological limits now?” in Robotics and Automation, 2002. Proceedings. ICRA'02. IEEE International Conference on, vol. 2. IEEE, 2002, pp. 1710-1716.
[23]: L. Johannsmeier and S. Haddadin, “A hierarchical human-robot interaction-planning framework for task allocation in collaborative industrial assembly processes,” IEEE Robotics and Automation Letters, vol. 2, no. 1, pp. 41-48, 2017.
[24]: R. Calandra, A. Seyfarth, J. Peters, and M. P. Deisenroth, “An experimental comparison of bayesian optimization for bipedal locomotion,” in Robotics and Automation (ICRA), 2014 IEEE International Conference on. IEEE, 2014, pp. 1951-1958.
[25]: J. Snoek, “Bayesian optimization and semiparametric models with applications to assistive technology,” Ph.D. dissertation, University of Toronto, 2013.
[26]: J. Snoek, H. Larochelle, and R. P. Adams, “Practical bayesian optimization of machine learning algorithms,” in Advances in neural information processing systems, 2012, pp. 2951-2959.
[27]: E. Brochu, V. M. Cora, and N. De Freitas, “A tutorial on bayesian optimization of expensive cost functions, with application to active user modeling and hierarchical reinforcement learning,” arXiv preprint arXiv:1012.2599, 2010.
[28]: K. Swersky, J. Snoek, and R. P. Adams, “Multi-task bayesian optimiza-tion,” in Advances in neural information processing systems, 2013, pp. 2004-2012.
[29]: R. M. Neal, “Slice sampling,” Annals of statistics, pp. 705-741, 2003. [30] J. M. Herna\acute{ }ndez-Lobato, M. A. Gelbart, M. W. Hoffman, R. P. Adams, and Z. Ghahramani, “Predictive entropy search for bayesian optimization with unknown constraints.” in ICML, 2015, pp. 1699-1707.

### BRIEF DESCRIPTION OF THE DRAWINGS

In the drawings:

FIG. 1 shows a peg-in-hole skill according to a first embodiment of the invention;

FIG. 2 shows a conceptual sketch of skill dynamics according to another embodiment of the invention;

FIG. 3 shows a method for controlling actuators of an articulated robot according to a third embodiment of the invention;

FIG. 4 shows a system for controlling actuators of an articulated robot and enabling the robot executing a given task according to another embodiment of the invention;

FIG. 5 shows the system of FIG. 4 in a different level of detail; and

FIG. 6 shows a system for controlling actuators of an articulated robot and enabling the robot executing a given task according to another embodiment of the invention.

### DETAILED DESCRIPTION

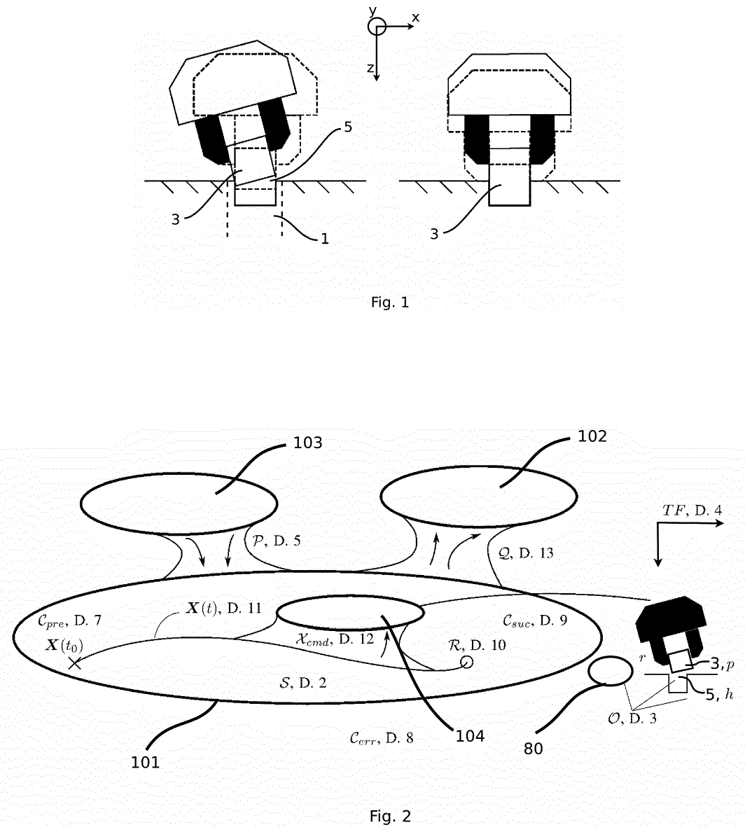

In FIG. 1, the application of the skill framework for the standard manipulation problem, i.e., the skill “peg-in-hole”, is shown. On the left half of the picture, the robot 80 is located in a suitable region of interest ROI 1, with the grasped peg 3 being in contact with the surface of an object with a hole 5. The skill commands velocities resulting from a velocity based search algorithm, aiming at finding the hole 5 with according alignment and subsequently inserting the peg 3 into the hole 5. In the alignment phase a feed forward force is applied downwards-vertical (downwards in FIG. 1) and to the left. Simultaneously, the alignment movement consists of basic rotations around two horizontal axes (from left to right and into the paper plane in FIG. 1). During the insertion phase, the skill commands \dot{x}_{d,z} until x_{d} reached a desired depth. At the same time, perpendicular Lissajous velocities \dot{x}_{d,x}, \dot{x}_{d,y} are overlaid. If the peg 3 reaches the desired depth the skill was successful. The skill is defined as follows:

S={x, R, Fₑₓₜ, τₑₓₜ}, where x∈ [symbol] ³ is the position in Cartesian space, R∈ [symbol] ^{3×3} is the orientation, Fₑₓₜ=[fₑₓₜ, mₑₓₜ]^{T}∈ [symbol] ⁶ is the wrench of the external forces and torques and τₑₓₜ∈ [symbol] ⁿ is the vector of external torques where n denotes the number of joints. Objects O=[r, p, h], where r is the robot 80, p the object or peg 3 grasped with the robot 80 and h the hole 5. Cₚᵣₑ={X∈S|f_{ext,z}>f_{contact}, x∈U(x), g(r, p)=1} states that the robot 80 shall sense a specified contact force f_{contact} and the peg 3 has to be within the region of interest ROI 1, which is defined by U(⋅). The function g(r,p) simplifies the condition of the robot r 80 having grasped the peg p 3 to a binary mapping. C_{suc}={X∈S|x_{z}>x_{z,0}+d} which states that the peg 3 has to be partially inserted by at least d into the hole 5 for the skill to terminate successfully. Ideally d is the depth of the hole 5.

Cₑᵣᵣ={X∈S|x∉U(x), τₑₓₜ>τₘₐₓ} states that the skill fails if the robot 80 leaves the ROI 1 or the external torques exceed some specified safety limit component wise. P={Pₜ, Pₗ} with Pₜ={a, d, \tilde{T}, r} and Pₗ={αₜ, αᵣ, βₜ, βᵣ, F_{ff,0}, vₜ, vᵣ}. a is the amplitude of the Lissajous curves, d is the desired depth, \tilde{T} is the pose estimation of the hole 5 and r is the radius of the region of interest ROI 1. The controller parameters α, β and F_{ff,0} are applied as in the above shown general description. v is a velocity and the indices t, r refer to translational and rotational directions, respectively. Qₜᵢₘₑ={tₑ−tₛ, f_{z,max}=maxₜ f_{ext,z}}, where tₑ and tₛ are the start and end time of the skill execution and f_{ext,z} is the external force in z-direction. This metric aims to minimize execution time and comply to a maximum level of contact forces in the direction of insertion simultaneously.

FIG. 2 shows a conceptual sketch of skill dynamics. At execution start, all coordinates, i.e., all physical objects O, reside in Cₚᵣₑ of S for which the preconditions hold. The skill dynamics then drive the system through skills space towards the success condition C_{suc} and ultimately to the nominal result R. The valid skill space is surrounded by Cₑᵣᵣ. The abbreviation “D.<Number>” refers to the following definitions, such that, e.g., “D.4” refers to Definition 4 from the upcoming description. The skill provides desired commands and trajectories to the adaptive controller 104 together with meta parameters and other relevant quantities for executing the task. In addition, a skill contains a quality metric and parameter domain to the learning algorithm of the learning unit 103, while receiving the learned set of parameters used in execution. The adaptive controller 104 commands the robot hardware via desired joint torques and receives sensor feedback. Finally, the skill formalism makes it possible to easily connect to a high-level task planning module. The following preferred skill formalism is applied:

Definition 1 (Skill): A skill s is an element of the skill-space. It is defined as a tuple (S, O, Cₚᵣₑ, Cₑᵣᵣ, C_{suc}, R, χ_{cmd}, X, P, Q).

Definition 2 (Space): Let S be the Cartesian product of I subspaces ζᵢ= [symbol] ^{m}^{ᵢ}^{×n}^{ᵢ} relevant to the skill s, i.e.: S=ζᵢ₌₁×ζᵢ₌₂× . . . ×ζ_{i=I} with i={1, 2, . . . , I} and I≥2, wherein the subspaces ζᵢ include a control variable and an external wrench including an external force and an external moment.

Definition 3 (Object): Let o represent a physical object with coordinates ^{o}X(t)∈S associated with it. O denotes the set of all objects o∈O relevant to a skill s with nₒ=|O| and nₒ>0. Moreover, X(t) is defined as X(t)=(^{o}^{₁}X(t), . . . , ^{o}^{ₙ}X(t))^{T}. In these considerations the set O is not changed during skill execution, i.e., nₒ=const.

Definition 4 (Task Frame): The task frame ^{o}R_{TF}(t) denotes the rotation from frame TF to the base frame O. It is assumed that ^{o}R_{TF}(t)=const.

Definition 5 (Parameters): P denotes the set of all skill parameters consisting of three subsets Pₜ, Pₗ and P_{D}. The set Pₜ⊂P contains all parameters resulting from a priori task knowledge, experience and the intention under which the skill is executed. It is referred to Pₜ also as task specification. The set Pₗ⊂P contains all other parameters that are not necessarily known beforehand and need to be learned or estimated. In particular, it contains the meta parameters (α, β, γ_{α}, γ_{β}) for the adaptive controller 104. The third subset P_{D}⊂P defines the valid domain for Pₗ, i.e., it consists of intervals of values for continuous parameters or sets of values for discrete ones. Thus, P_{D} determines the boundaries when learning Pₗ.

Conditions: There are three condition types involved in the execution of a skill: preconditions, failure conditions and success conditions. They all share the same basic definition, yet their application is substantially different. Their purpose is to define the borders and limits of the skill from start to end:

Definition 6 (Condition): Let C⊂S be a closed set and c(X(t)) a function c: S→B where B={0, 1}. A condition holds iff c(X(t))=1. The mapping itself depends on the specific type of condition.

Definition 7 (Precondition): Cₚᵣₑ denotes the chosen set for which the precondition defined by cₚᵣₑ(X(t)) holds. The condition holds, i.e., cₚᵣₑ(X(t₀))=1, iff ∀ x∈X: x(t₀)⊂Cₚᵣₑ. to denotes the time at start of the skill execution. This means that at the beginning of skill execution the coordinates of every involved object must lie in Cₚᵣₑ.

Definition 8 (Error Condition): Cₑᵣᵣ denotes the chosen set for which the error condition cₑᵣᵣ(X(t)) holds, i.e., cₑᵣᵣ(X(t))=1. This follows from ∃ x∈X: x(t)∈Cₑᵣᵣ. If the error condition is fulfilled at time t, skill execution is interrupted. No assumptions are made about how this error state is resolved since this depends on the actual skill implementation and the capabilities of high-level control and planning agency.

Definition 9 (Success Condition): C_{suc} denotes the chosen set for which the success condition defined by c_{suc}(X(t)) holds, i.e., c_{suc}(X(t))=1 iff ∀ x∈X: x(t)∈C_{suc}. If the coordinates of all involved objects are within C_{suc} the skill execution can terminate successfully.

Definition 10 (Nominal Result): The nominal result R∈S is the ideal endpoint of skill execution, i.e., the convergence point.

Although the nominal result R is the ideal goal of the skill, its execution is nonetheless considered successful if the success conditions C_{suc}. holds. Nonetheless X(t) converges to this point.

Definition 11 (Skill Dynamics): Let X:[t₀,∞]→P be a general dynamic process, where t₀ denotes the start of the skill execution. The process terminates if (∀ c_{suc}∈C_{suc}: c_{suc}(X(t))=1)∨(∃cₑᵣᵣ∈Cₑᵣᵣ: cₑᵣᵣ(X(t))=1).

It converges to the nominal result R. This dynamic process encodes what the skill actually does depending on the input, i.e., the concrete implementation. This is a trajectory generator, a DMP, or some other algorithm calculating sensor based velocity or force commands. The finish time tₑ is not necessarily known a priori. For a search skill it cannot be determined when it terminates because of the very nature of the search problem.

Definition 12 (Commands): Let χ_{cmd}⊂X(t) be the skill commands, i.e., a desired trajectory consisting of velocities and forces defined in TF sent to the controller.

Definition 13 (Quality Metric): Q denotes the set of all 2-tuples (w,f_{q}(X(t)) with 0<w<1 and constraints f_{c,i}(X(t)). Furthermore let q=Σᵢwᵢf_{q,i}(X(t))∀(wᵢ,f_{q,i}(X(t)))∈Q.

The quality metric is a means of evaluating the performance of the skill and to impose quality constraints on it. This evaluation aims at comparing two different implementations of the same skill or two different sets of parameters P. The constraints are used to provide a measure of quality limits for a specific task (e.g., a specific time limit). The quality metric reflects some criterion that is derived from the overall process in which the skill is executed or given by a human supervisor.

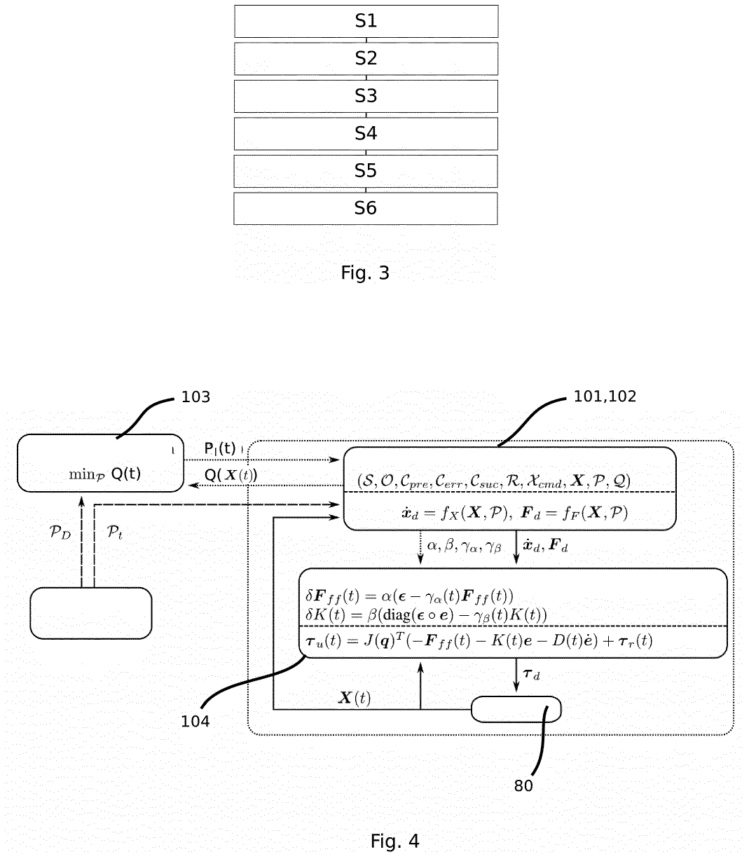

FIG. 3 shows a method for controlling actuators of an articulated robot 80 and enabling the robot 80 executing a given task, the robot 80 including a first unit 101, a second unit 102, a learning unit 103, and an adaptive controller 104, the second unit 102 being connected to the first unit 101 and further to a learning unit 103 and to an adaptive controller 104, including the following steps:
providing S1 a specification of robot skills s selectable from a skill space depending on the task by a first unit 101, with a robot skill s being defined as a 2-tuple out of (S, O, Cₚᵣₑ, Cₑᵣᵣ, C_{suc}, R, χ_{cmd}, X, P, Q) with

S: a Cartesian product of I subspaces ζᵢ: S=ζᵢ₌₁×ζᵢ₌₂× . . . ×ζ_{i=I}

with i={1, 2, . . . , I} and I≥2,

O: a set of all objects,

Cₚᵣₑ: a precondition,

Cₑᵣᵣ: an error condition,

C_{suc}: a success condition,

R: a nominal result of ideal skill execution,

χ_{cmd}: skill commands,

X: physical coordinates,

P: skill parameters, with P consisting of three subsets Pₜ, Pₗ, P_{D}, with Pₜ being the parameters resulting from a priori knowledge of the task, Pₗ being the parameters not known initially and need to be learned and/or estimated during execution of the task, and P_{D} being constraints of parameters Pₗ,

Q: a performance metric, while Q(t) is denoting the actual performance of the skill carried out by the robot 80,
an adaptive controller 104 receiving S2 skill commands χ_{cmd} from a second unit 102, wherein the second unit 102 is connected to the first unit 101 and further to a learning unit 103 and to the adaptive controller 104 and wherein the skill commands χ_{cmd} include the skill parameters Pₗ,
controlling S3 the actuators of the robot 80 by the adaptive controller 104 and based on the skill commands χ_{cmd}, wherein the actual status of the robot 80 is sensed by respective sensors and/or estimated by respective estimators and fed back to the controller 104 and to the second unit 102,
determining S4 by the second unit 102 and based on the actual status, the performance Q(t) of the skill carried out by the robot 80,
the learning unit 103 receiving S5 P_{D} and Q(t) from the second unit 102, and
determining S6 updated skill parameters Pₗ(t) and providing Pₗ(t) to the second unit 102 and replacing hitherto existing skill parameters Pₗ, wherein the subspaces ζᵢ include a control variable and an external wrench including, in particular, an external force and an external moment.

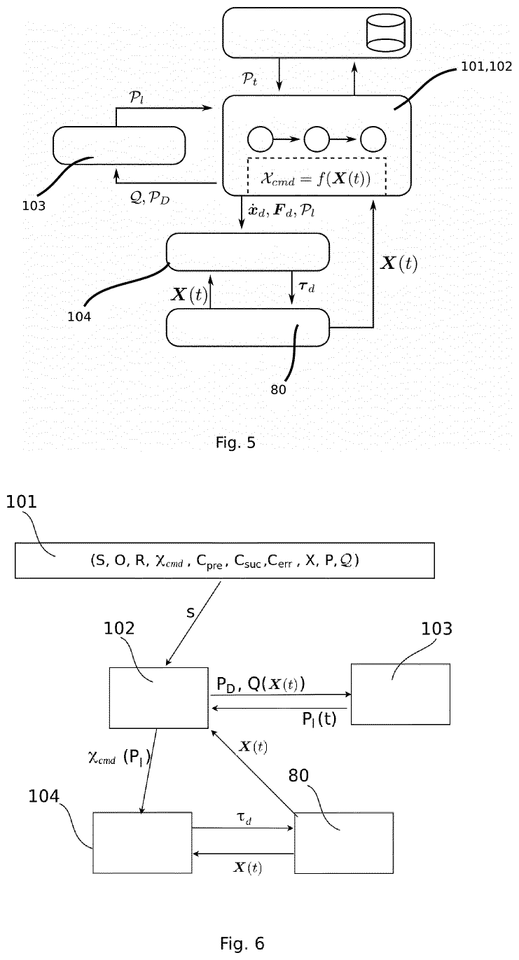

Each of FIGS. 4 and 5 shows a system for controlling actuators of an articulated robot 80 and enabling the robot 80 executing a given task in different levels of detail. Each system including:
a first unit 101 providing a specification of robot skills s selectable from a skill space depending on the task, with a robot skill s being defined as a tuple out of (S, O, Cₚᵣₑ, Cₑᵣᵣ, C_{suc}, R, χ_{cmd}, X, p, Q) with

S: a Cartesian product of I subspaces ζᵢ: S=ζᵢ₌₁×ζᵢ₌₂× . . . ×ζ_{i=I}

with i{1, 2, . . . , I} and I≥2,

O: a set of all physical objects,

Cₚᵣₑ: a precondition,

Cₑᵣᵣ: an error condition,

C_{suc}: a success condition,

R: nominal result of ideal skill execution,

χ_{cmd}: skill commands,

X: physical coordinates,

P: skill parameters, with P consisting of three subsets Pₜ, Pₗ, P_{D}, with Pₜ being the parameters resulting from a priori knowledge of the task, Pₗ being the parameters not known initially and need to be learned and/or estimated during execution of the task, and P_{D} being constraints of parameters Pₗ,

Q: a performance metric, while Q(t) is denoting the actual performance of the skill carried out by the robot 80,
a second unit 102, wherein the second unit 102 is connected to the first unit 101 and further to a learning unit 103 and to an adaptive controller 104, wherein the adaptive controller 104 receives skill commands χ_{cmd}, wherein the skill commands χ_{cmd} include the skill parameters Pₗ, wherein based on the skill commands χ_{cmd} the controller 104 controls the actuators of the robot 80, wherein the actual status X(t) of the robot 80 is sensed by respective sensors and/or estimated by respective estimators and fed back to the controller 104 and to the second unit 102, wherein based on the actual status X(t), the second unit 102 determines the performance Q(t) of the skill carried out by the robot 80, and wherein the learning unit 103 receives P_{D}, and Q(t) from the second unit 102, determines updated skill parameters Pₗ(t) and provides Pₗ(t) to the second unit 102 to replace hitherto existing skill parameters Pₗ, wherein the subspaces ζᵢ include a control variable and an external wrench including an external force and an external moment. The skill commands χ_{cmd} include the skill parameters P within the desired force F_{d}, and F_{d}, which is dependent on P via F_{d}=f_{F}(X, P), wherein Pₗ is one of the three subsets of P. Likewise the desired velocity \dot{x}_{d} is dependent on P and therefore also on Pₗ with \dot{x}_{d}=fₓ(X, P). The parameter Pₜ is herein received from a database of a planning and skill surveillance unit, symbolized by a stacked cylinder.

FIG. 6 shows a system for controlling actuators of an articulated robot 80 and enabling the robot 80 executing a given task, including:
a first unit 101 providing a specification of robot skills s selectable from a skill space depending on the task, with a robot skill s being defined as a tuple from (S, O, Cₚᵣₑ, Cₑᵣᵣ, C_{suc}, R, χ_{cmd}, X, p, Q). The expressions of this tuple are defined as follows:

S: a Cartesian product of I subspaces ζᵢ: S=ζᵢ₌₁×ζᵢ₌₂× . . . ×ζ_{i=I}

with i={1, 2, . . . , I} and I≥2,

O: a set of all physical objects,

Cₚᵣₑ: a precondition,

Cₑᵣᵣ: an error condition,

C_{suc}: a success condition,

R: a nominal result of ideal skill execution,

χ_{cmd}: skill commands,

X: physical coordinates,

P: skill parameters, with P consisting of three subsets Pₜ, Pₗ, P_{D}, with Pₜ being the parameters resulting from a priori knowledge of the task, Pₗ being the parameters not known initially and need to be learned and/or estimated during execution of the task, and P_{D} being constraints of parameters Pₗ,

Q: a performance metric, wherein Q(t) is denoting the actual performance of the skill carried out by the robot 80,
a second unit 102, wherein the second unit 102 is connected to the first unit 101 and further to a learning unit 103 and to an adaptive controller 104,

wherein the adaptive controller 104 receives skill commands χ_{cmd},

wherein the skill commands χ_{cmd} include the skill parameters Pₗ,

wherein based on the skill commands χ_{cmd} the controller 104 controls the actuators of the robot 80 via a control signal τ_{d}, wherein the actual status X(t) of the robot 80 is sensed by respective sensors and/or estimated by respective estimators and fed back to the controller 104 and to the second unit 102, wherein based on the actual status X(t), the second unit 102 determines the performance Q(t) of the skill carried out by the robot 80, and wherein the learning unit 103 receives P_{D}, and Q(t) from the second unit 102, determines updated skill parameters Pₗ(t) and provides Pₗ(t) to the second unit 102 to replace hitherto existing skill parameters Pₗ.

### LIST OF REFERENCE NUMERALS

1 Region of interest ROI
3 Peg
5 Hole
80 Robot
101 First unit
102 Second unit
103 Learning unit
104 Adaptive controller
S1 Providing
S2 Receiving
S3 Controlling
S4 Determining
S5 Receiving
S6 Determining

1. A system to control actuators of an articulated robot and enabling the robot executing a given task, the system comprising:
a first unit to provide a specification of robot skills s selectable from a skill space depending on the task, with a robot skill s being defined as a tuple (S, O, Cₚᵣₑ, Cₑᵣᵣ, C_{suc}, R, χ_{cmd}, X, P, Q) with
S: a Cartesian product of I subspaces ζᵢ: S=ζᵢ₌₁×ζᵢ₌₂× . . . ×ζ_{i=I}
with i={1, 2, . . . , I} and I≥2,
O: a set of physical objects,
Cₚᵣₑ: a precondition,
Cₑᵣᵣ: an error condition,
C_{suc}: a success condition,
R: nominal result of ideal skill execution,
χ_{cmd}: skill commands,
X: physical coordinates,
P: skill parameters, with P consisting of three subsets Pₜ, Pₗ, P_{D}, with Pₜ being skill parameters resulting from a priori knowledge of the task, Pₗ being skill parameters not known initially and need to be learned and/or estimated during execution of the task, and P_{D} being constraints of the skill parameter Pₗ,
Q: a performance metric, wherein Q(t) denotes actual performance of the skill carried out by the robot; and
a second unit connected to the first unit, and further connected to a learning unit and to an adaptive controller,
wherein the adaptive controller receives the skill commands χ_{cmd},
wherein the skill commands χ_{cmd} comprise the skill parameters Pₗ,
wherein based on the skill commands χ_{cmd} the controller controls the actuators of the robot,
wherein actual status of the robot is sensed by respective sensors and/or estimated by respective estimators and fed back to the controller and to the second unit,
wherein based on the actual status, the second unit determines the performance value Q(t) of the skill carried out by the robot, and
wherein the learning unit receives P_{D}, and Q(t) from the second unit, determines updated skill parameters Pₗ(t) and provides Pₗ(t) to the second unit to replace hitherto existing skill parameters Pₗ.

2. The system according to claim 1, wherein the adaptive controller adapts feed forward wrench and stiffness via δF_{ff}=F_{ff}(t)−F_{ff}(t−T).

3. The system according to claim 1, wherein the learning unit carries out a Bayesian and/or a HiREPS optimization or learning.

4. The system according to claim 1, wherein the system comprises a data interface with a data network, and wherein the system is designed and set up to download system-programs for setting up and controlling the system from the data network.

5. The system according to claim 4, wherein the system is designed and set up to download parameters for the system-programs from the data network.

6. The system according to claim 1, wherein the system is designed and set up to enter parameters for the system-programs via a local input-interface and/or via a teach-in-process, with the robot being manually guided.

7. The system according to claim 4, wherein the system is designed and set up such that downloading system-programs and/or respective parameters from the data network is controlled by a remote station, and wherein the remote station being part of the data network.

8. The system according to claim 4, wherein the system is designed and set up such that system-programs and/or respective parameters locally available at the system are sent to one or more participants of the data network based on a respective request received from the data network.

9. The system according to claim 4, wherein the system is designed and set up such that system-programs with respective parameters available locally at the system can be started from a remote station, and wherein the remote station is part of the data network.

10. The system according to claim 6, wherein the system is designed and set up such that the remote station and/or the local input-interface comprises a human-machine-interface HMI designed and setup for entry of system-programs and respective parameters and/or for selecting system-programs and respective parameters from a multitude system-programs and respective parameters.

11. The system according to claim 10, wherein the human-machine-interface HMI is designed and setup such that entries are possible via “drag-and-drop”-entry on a touchscreen, a guided dialogue, a keyboard, a computer-mouse, a haptic interface, a virtual-reality-interface, an augmented reality interface, an acoustic interface, via a body tracking interface, based on electromyographic data, based on elektroenzephalographic data, via a neuronal interface, or a combination thereof.

12. The system according to claim 10, wherein the human-machine-interface HMI is designed and setup to deliver auditive, visual, haptic, olfactoric, tactile, or electrical feedback, or a combination thereof.

13. An articulated robot to control actuators enabling the robot to execute a given task, the robot comprising:
a first unit to provide a specification of robot skills s selectable from a skill space depending on the task, with a robot skill s being defined as a tuple
(S, O, Cₚᵣₑ, Cₑᵣᵣ, C_{suc}, R, χ_{cmd}, X, P, Q) with
S: a Cartesian product of I subspaces ζᵢ: S=ζᵢ₌₁×ζᵢ₌₂× . . . ×ζ_{i=I}
with i={1, 2, . . . , I} and I≥2,
O: a set of physical objects,
Cₚᵣₑ: a precondition,
Cₑᵣᵣ: an error condition,
C_{suc}: a success condition,
R: nominal result of ideal skill execution,
χ_{cmd}: skill commands,
X: physical coordinates,
P: skill parameters, with P consisting of three subsets Pₜ, Pₗ, P_{D}, with Pₜ being the parameters resulting from a priori knowledge of the task, Pₗ being the parameters not known initially and need to be learned and/or estimated during execution of the task, and P_{D} being constraints of parameters Pₗ,
Q: a performance metric, wherein Q(t) is denoting the actual performance of the skill carried out by the robot; and
a second unit connected to the first unit and further to a learning unit and to an adaptive controller;
wherein the adaptive controller receives skill commands χ_{cmd},
wherein the skill commands χ_{cmd} comprise the skill parameters Pₗ,
wherein based on the skill commands χ_{cmd} the controller controls the actuators of the robot,
wherein the actual status of the robot is sensed by respective sensors and/or estimated by respective estimators and fed back to the controller and to the second unit,
wherein based on the actual status, the second unit determines the performance value Q(t) of the skill carried out by the robot, and
wherein the learning unit receives P_{D}, and Q(t) from the second unit, determines updated skill parameters Pₗ(t) and provides Pₗ(t) to the second unit to replace hitherto existing skill parameters Pₗ.

14. A method of controlling actuators of an articulated robot and enabling the robot to execute a given task, the robot comprising a first unit, a second unit, a learning unit, and an adaptive controller, the second unit being connected to the first unit and further to the learning unit and to the adaptive controller, the method comprising:
providing a specification of robot skills s selectable from a skill space depending on the task by a first unit, with a robot skill s being defined as a tuple (S, O, Cₚᵣₑ, Cₑᵣᵣ, C_{suc}, R, χ_{cmd}, X, P, Q) with
S: a Cartesian product of I subspaces ζᵢ: S=ζᵢ₌₁×ζᵢ₌₂× . . . ×ζ_{i=I}
with i={1, 2, . . . , I} and I≥2,
O: a set of physical objects,
Cₚᵣₑ: a precondition,
Cₑᵣᵣ: an error condition,
C_{suc}: a success condition,
R: nominal result of ideal skill execution,
χ_{cmd}: skill commands,
X: physical coordinates,
P: skill parameters, with P consisting of three subsets Pₜ, Pₗ, P_{D}, with Pₜ being the parameters resulting from a prion knowledge of the task, Pₗ being the parameters not known initially and need to be learned and/or estimated during execution of the task, and P_{D} being constraints of parameters Pₗ,
Q: a performance metric, while Q(t) is denoting the actual performance of the skill carried out by the robot,
the adaptive controller receiving skill commands χ_{cmd} from the second unit, wherein the skill commands χ_{cmd} comprise the skill parameters Pₗ,
controlling the actuators of the robot by the controller and based on the skill commands χ_{cmd}, wherein the actual status of the robot is sensed by respective sensors and/or estimated by respective estimators and fed back to the controller and to the second unit,
determining by the second unit and based on the actual status, the performance value Q(t) of the skill carried out by the robot,
the learning unit receiving (S5) P_{D} and Q(t) from the second unit, and
determining updated skill parameters Pₗ(t) and providing Pₗ(t) to the second unit and replacing hitherto existing skill parameters Pₗ.

15. (canceled)

16. A system to control actuators of an articulated robot and enable the robot to execute a given task, the robot comprising a first unit, a second unit, a learning unit, and an adaptive controller, the second unit being connected to the first unit and further to the learning unit and to the adaptive controller, the system comprising:
a data processing unit; and
a storage medium storing instructions that, when executed by the data processing unit, enables the data processing unit to perform operations comprising:
providing a specification of robot skills s selectable from a skill space depending on the task by a first unit, with a robot skill s being defined as a tuple (S, O, Cₚᵣₑ, Cₑᵣᵣ, C_{suc}, R, χ_{cmd}, X, P, Q) with
S: a Cartesian product of I subspaces ζᵢ: S=ζᵢ₌₁×ζᵢ₌₂× . . . ×ζ_{i=I}
with i={1, 2, . . . , I} and I≥2,
O: a set of physical objects,
Cₚᵣₑ: a precondition,
Cₑᵣᵣ: an error condition,
C_{suc}: a success condition,
R: nominal result of ideal skill execution,
χ_{cmd}: skill commands,
X: physical coordinates,
P: skill parameters, with P consisting of three subsets Pₜ, Pₗ, P_{D}, with Pₜ being the parameters resulting from a prion knowledge of the task, Pₗ being the parameters not known initially and need to be learned and/or estimated during execution of the task, and P_{D} being constraints of parameters Pₗ,
Q: a performance metric, while Q(t) is denoting the actual performance of the skill carried out by the robot,
the adaptive controller receiving skill commands χ_{cmd} from the second unit, wherein the skill commands χ_{cmd} comprise the skill parameters Pₗ;
controlling the actuators of the robot by the controller and based on the skill commands χ_{cmd}, wherein the actual status of the robot is sensed by respective sensors and/or estimated by respective estimators and fed back to the controller and to the second unit;
determining by the second unit and based on the actual status, the performance value Q(t) of the skill carried out by the robot;
the learning unit receiving (S5) P_{D} and Q(t) from the second unit; and
determining updated skill parameters Pₗ(t) and providing Pₗ(t) to the second unit and replacing hitherto existing skill parameters Pₗ.

17. A non-transitory storage medium storing instructions that, when executed by the data processing unit, enables the data processing unit to perform operations to control actuators of an articulated robot and enable the robot to execute a given task, the robot comprising a first unit, a second unit, a learning unit, and an adaptive controller, the second unit being connected to the first unit and further to the learning unit and to the adaptive controller, the operations comprising:
providing a specification of robot skills s selectable from a skill space depending on the task by a first unit, with a robot skill s being defined as a tuple (S, O, Cₚᵣₑ, Cₑᵣᵣ, C_{suc}, R, χ_{cmd}, X, P, Q) with
S: a Cartesian product of I subspaces ζᵢ: S=ζᵢ₌₁×ζᵢ₌₂× . . . ×ζ_{i=I}
with i={1, 2, . . . , I} and I≥2,
O: a set of physical objects,
Cₚᵣₑ: a precondition,
Cₑᵣᵣ: an error condition,
C_{suc}: a success condition,
R: nominal result of ideal skill execution,
χ_{cmd}: skill commands,
X: physical coordinates,
P: skill parameters, with P consisting of three subsets Pₜ, Pₗ, P_{D}, with Pₜ being the parameters resulting from a prion knowledge of the task, Pₗ being the parameters not known initially and need to be learned and/or estimated during execution of the task, and P_{D} being constraints of parameters Pₗ,
Q: a performance metric, while Q(t) is denoting the actual performance of the skill carried out by the robot,
the adaptive controller receiving skill commands χ_{cmd} from the second unit, wherein the skill commands χ_{cmd} comprise the skill parameters Pₗ;
controlling the actuators of the robot by the controller and based on the skill commands χ_{cmd}, wherein the actual status of the robot is sensed by respective sensors and/or estimated by respective estimators and fed back to the controller and to the second unit;
determining by the second unit and based on the actual status, the performance value Q(t) of the skill carried out by the robot;
the learning unit receiving (S5) P_{D} and Q(t) from the second unit; and
determining updated skill parameters Pₗ(t) and providing Pₗ(t) to the second unit and replacing hitherto existing skill parameters Pₗ.

18. (canceled)

19. (canceled)
